(19) United States
(12) Patent Application Publication
(10) Pub. No.: US 2018/0102028 A1
(43) Pub. Date: Apr. 12, 2018

(54) Multilevel buyin poker game

(71) Applicants: LENA NGOC EVANS, SAN DIEGO, CA (US); RANJIT SINGH RANDHAWA, SAN DIEGO, CA (US)

(72) Inventors: LENA NGOC EVANS, SAN DIEGO, CA (US); RANJIT SINGH RANDHAWA, SAN DIEGO, CA (US)

(21) Appl. No.: 15/289,201

(22) Filed: Oct. 9, 2016

(51) Int. Cl. G07F 17/32

(52) U.S. Cl. CPC G07F 17/3276; G07F 17/3293; G07F 17/3258; G07F 17/3248; G07F 17/3225

(57) ABSTRACT

A multi-level buy-in poker game or tournament and a system for conducting the same, comprising an initial level of play with a predetermined entry cost and initial starting chip stack, followed by increasing entry costs and starting chip stacks during each subsequent level of entry, determined by number of players remaining, average chip stacks, the current blind structure and potential prize pool. This system, along with the element referred to as Chip Escalator, is designed to create an equitable playing environment for players to enter at different increasing levels for an entry cost and chip allotment which is determined to be average or medium and for that level.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present invention relates to the poker game and, includes a method for conducting poker tournaments.

### Description of the Related Art

Poker games and tournaments have grown in popularity due not only to increased television programming specializing in poker, and also boosted by the ever expanding ability to access poker online. Poker rooms across the country have seen increasing numbers of amateurs drawn to poker due to the increased visibility of televised poker, and also because of the increasing prize pool for tournaments.

While the general public debates whether poker is a game of chance or skill, within the poker community, there is no such debate. It has been determined by multiple studies and some courts of law that poker is absolutely a game of skill. Despite the skill factor needed to succeed in tournament poker, there remain factors which make it inequitable for players who enter late during the registration period or intend to re-enter a tournament once they have been eliminated.

Despite the factors which may limit a player's success in tournament play, many players still choose to play due to the possibility of a large payday. Registering late or re-entering, which is very common in tournament poker, puts the player at a big disadvantage due to factors such as receiving a starting chip stack only equal to those who registered on time, and the ever-increasing blind structure. matrix Poker, LLC has devised a system which creates a more equitable playing field for tournament players to enter play, no matter if the player registers on time, enters hours late, or re-enters after being eliminated.

The ability to escalate a player's chip stack—or enter tournament play at any level with the current average chip stack, does not currently exist anywhere in the poker industry, either in live or online tournaments, but the present invention has this ability.

### BRIEF SUMMARY OF THE INVENTION

In one aspect, Chip Escalator provides an advantage to tournament players who enter late, or re-enter play after elimination, by giving players the current average chip stack at the present level, rather than the initial chip allotment—which is the current industry norm.

In another aspect, with Chip Escalator, players have a more equitable chance at cashing or being “in the money” at any point of entrance, rather than entering “short stacked,” which is current industry norm, but a big disadvantage when trying to cash in tournaments.

All players who register on time and are seated at the beginning of a poker tournament receive the same starting chip stack, thus have an equal number of big blinds (calculated by dividing the number of starting chips received by the present big blind).

As an example: if the starting chip stack received is 10,000 for a buy-in amount of $200, and the starting blind level is 100, then the player has 100 big blinds. Players who register late, re-enter after elimination, or enter at a later level, based on industry standard still receive the original starting chip stack of 10,000 and pay the same buyin of $200. Unfortunately, the relative or intrinsic value of the 10,000 chips has decreased due to player eliminations and the ever increasing blind structure.

As an additional example; if the player registers late and enters the tournament in the 3rd big blind level, which is now at 300, the player receives the same starting stack of 10,000, which is now only the equivalent of 33 big blinds for that same $200 buy-in. If a player is eliminated in the 3rd level and chooses to re-enter in the 4th big blind level, where the big blind is now 400, the player only receives 25 big blinds for that same $200 buy-in and for the same 10,000 starting stack.

matrix Poker, LLC has devised a formula which makes it much more equitable for players to register and enter a tournament late, or re-enter after elimination. Many factors are taken into account when devising this formula, including the number of players entered, number of players remaining at the current blind structure, the amount of the big blind at each entry level, the dollar cost of initial buy-in and the payout structure.

As an example, if 100 players enter a tournament on time, and they each receive 10,000 starting chips for $200, then there are 1,000,000 million chips in play, with each player having an average of 100 big blinds. If 30 players have been eliminated through [symbol] $300, receiving 50% more chips for a buyin amount 50% more than the initial buy-in amount at the onset of the tournament.

### DESCRIPTION OF THE DRAWINGS

For a more complete understanding of the present invention, reference is now made to the following descriptions:

FIG. 1 Is a process flow chart of one embodiment of a method for playing a multilevel poker game or tournament.

FIG. 2 Is a process flow chart of one embodiment of a method for playing a multilevel poker game or tournament.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

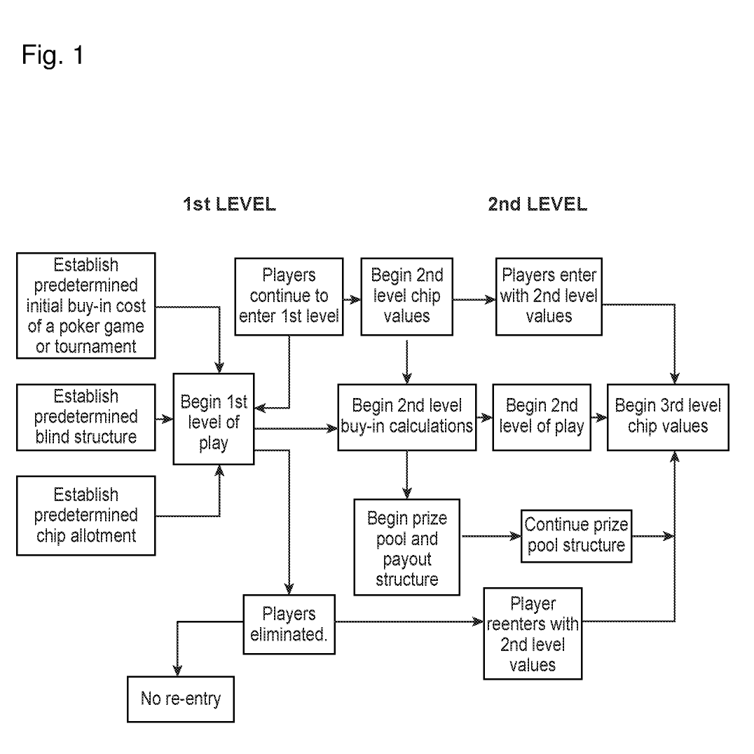

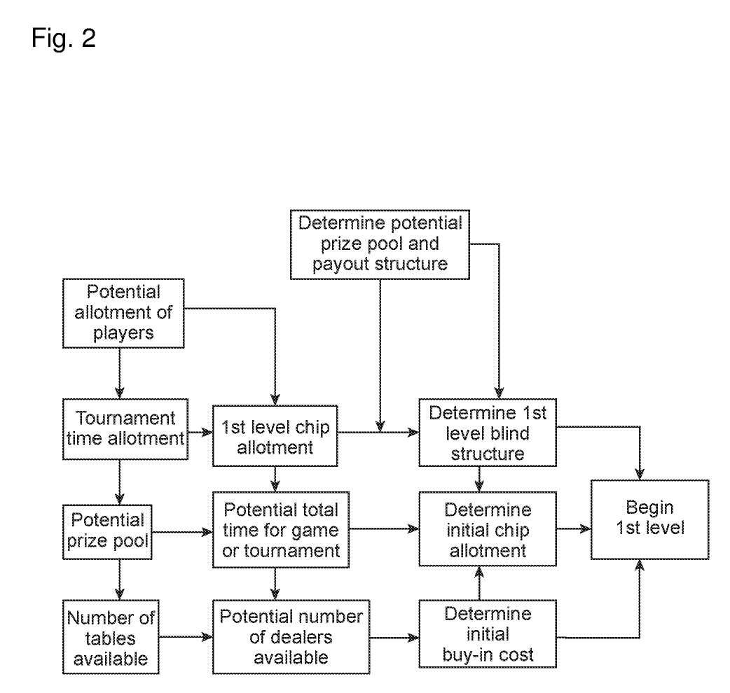

Referring to FIG. 1 and FIG. 2, Chip Escalator is a unique, industry-disrupting element of poker tournament structure, which allows players of varying bankrolls to enter a tournament at different stages to compete for the same prize pool, while also accommodating late arrivals and re-entries. Currently, tournament play is structured so all players pay the same entry fee and start with the same chip stacks. Players entering a tournament late whether 4 minutes or 4 hours, all pay the same entry fee and receive an equal initial chip stack. Chip Escalator allows players a more equitable entry into tournament play by calculating relative average chip values at the current blind level, assigning comparable chip stacks, and adjusting entry fees.

The current method of tournament play disincentivizes and does not accommodate late arrivals and re-entries, because players know they will receive the original starting stack and not the current average chip stack in play. Entering a tournament late causes a player to begin short stacked, therefore already putting him in a disadvantageous position.

After exhaustive research of many casinos and tournament structures, including the World Series of Poker, World Poker Tour, European Poker Tour, and Asian Pacific Tour, we discovered that no such element nor closely similar offering exists in the poker landscape.

The Chip Escalator structure of Play:

### Example

Initial buy-in: $200+$20 Entry fee=10,000 chips

Chip Escalator comes into play:

2nd level buy-in: $300+$25 Entry fee=15,000 chips

3rd level buy-in: $375+$30 Entry fee=20,000 chips

4th level buy-in: $425+$35 Entry fee=25,000 chips

5th level buy-in: $500+$40 Entry fee=30,000 chips

6th level buy-in: $575+$45 Entry fee=35,000 chips

7th level buy-in: $650+$50 Entry fee=40,000 chips

8th level buy-in: $725+$55 Entry fee=45,000 chips

The blind structure—or required forced bet, is one of the most important details of running a successful poker tournament. Gradual increases of the blinds at each level, and finishing on time, are characteristics of a desirable blind structure. To calculate blind structure, one would determine the potential number of players, target duration of time, and starting blind level.

All of the following elements were considered when devising the Chip Escalator method of entry into a tournament.

Starting number of blinds (a required forced bet). Note that the majority of poker tournaments provide a starting chip stack of 50-100 big blinds. Approximately 200 big blinds is considered a “deepstack” tournament. If all variants are held constant, starting a tournament with a larger chip stack will increase the length of the game.

Rebuys, re-entries, and add-ons. The number of rebuys (an option to rebuy back into a tournament if a player is eliminated or his chip stack falls below a certain number), as well as re-entries and add-ons (an option to buy more chips th

[symbol]

Finally, the present invention is a method for conducting a multilevel poker game, comprising conducting a first level in which players receive an initial predetermined allotment of chips at an initial predetermined cost of entry; and conducting additional levels in which players entering at subsequent increasing blind levels, receive an allotment of chips and entry cost, determined by the average number of players remaining, average chips per player in play, and the increasing prize pool;

[symbol]

What is claimed is:

1. A method for conducting a multilevel poker game, comprising:
conducting a first level in which players receive an initial predetermined allotment of chips at a predetermined entry cost;
conducting a first level in which players pay an initial predetermined cost of entry; and
conducting a second level in which players entering at subsequent increasing levels, receive an allotment of chips and entry cost, determined by the numbers of players remaining, average chips per player in play and the increasing prize pool.

2. The method according to claim 1, wherein said second level structure is triggered at the end of level one, and continuing sequentially until the tournament is in the money.

3. The method according to claim 1, wherein the game is conducted and timed electronically, based on the predetermined blind structure.

4. The method according to claim 1, wherein said predetermined initial blind structure is based on potential allotment of players.

5. The method according to claim 1, wherein said predetermined initial blind structure is based on time allotment available for said tournament.

6. The method according to claim 1, wherein said predetermined initial blind structure is based on potential prize pool.

7. The method according to claim 1, wherein said predetermined initial blind structure is based on number of tables available for said tournament.

8. The method according to claim 1, wherein said predetermined initial chip allotment is based on potential player pool.

9. The method according to claim 1, wherein said predetermined initial chip allotment is based on time allotment available.

10. The method according to claim 1, wherein said predetermined initial chip allotment is based on tables available.

11. The method according to claim 1, wherein said predetermined initial buyin cost is based on potential player pool.

12. The method according to claim 1, wherein said predetermined initial buyin cost is based on potential prize pool.

13. The method according to claim 1, wherein said predetermined initial buyin cost is based on numbers of tables available.

14. The method according to claim 1, wherein said predetermined initial buyin cost is based on time allotment.

15. The method according to claim 1, wherein determining the cost of entry from the 2nd level is sequentially based on players remaining, average chip stacks at current level and current prize pool.

16. The method according to claim 1, wherein determining the allotment of chips from the 2nd level is sequentially based on players remaining, average chip stacks at current level and current prize pool.

17. The method according to claim 1, wherein determining prize pool payouts is based on total entries, total prize pool, and number of players in the money or cashing.
